(19) United States
(12) Patent Application Publication
(10) Pub. No.: US 2026/0000215 A1
(43) Pub. Date: Jan. 1, 2026

(54) COVER FOR A SUPPORT SURFACE

(71) Applicant: UMANO MEDICAL INC., L'Islet (CA)

(72) Inventor: Claude BERNIER, Ste-Brigitte de Laval (CA)

(73) Assignee: UMANO MEDICAL INC., L'Islet (CA)

(21) Appl. No.: 19/237,175

(22) Filed: Jun. 13, 2025

Related U.S. Application Data
(60) Provisional application No. 63/664,904, filed on Jun. 27, 2024.

(51) Int. Cl. A47C 27/00; A47C 27/08

(52) U.S. Cl. CPC A47C 27/006; A47C 27/084

(57) ABSTRACT

A cover for a support surface includes: a ticking made of a ticking material configured to enclose a support layer of the support surface, the ticking having an outer top surface configured to face a person lying on the support surface; and a friction reducing overlay on at least a portion of the outer top surface for facilitating displacement of the person on the support surface, the friction reducing overlay being made of a low friction material formed onto the ticking material, the friction reducing overlay comprising a plurality of overlay elements that are spaced apart from each other to form an overlay pattern.

### CROSS-REFERENCE

The present application claims priority from U.S. Provisional Patent Application No. 63/664,904, filed Jun. 27, 2024, the entirety of which is incorporated by reference herein.

### FIELD OF TECHNOLOGY

The present technology relates to support surfaces such as mattresses, and particularly to covers of such support surfaces.

### BACKGROUND

A person's comfort when lying on a patient support apparatus such as a bed is important, particularly in a medical setting such as in a hospital or long-term living facility. Notably, in medical settings, besides having to comfortably support a patient lying thereon, beds are often movable between different positions to cause a patient to transition between different positions when lying on the bed. For example, a backrest of the bed can be selectively raised to place the patient in a seated position. However, during such a displacement, the patient lying on the bed can sometimes be subjected to some discomfort such as a light sensation of compression around the midsection.

Some prior art systems have attempted to attenuate this problem by optimizing a motion of the backrest of the bed. For example, a mechanism may be provided on the bed so that the motion of the backrest as it is raised includes an upward translation in addition to a rotation of the backrest. However, this may be expensive to implement and/or insufficient to address patients' discomfort.

Furthermore, it can often be challenging for caregivers to reposition a patient with reduced mobility in a bed. For instance, moving the patient toward a head end of the bed can require significant physical effort from caregivers which may sometimes lead to strain and/or injury.

In view of the foregoing, there is a need for a support surface that addresses at least some of these drawbacks.

### SUMMARY

It is an object of the present technology to ameliorate at least some of the inconveniences present in the prior art.

According to an aspect of the present technology, there is provided a cover for a support surface, comprising: a ticking made of a ticking material configured to enclose a support layer of the support surface, the ticking having an outer top surface configured to face a person lying on the support surface; and a friction reducing overlay on at least a portion of the outer top surface for facilitating displacement of the person on the support surface, the friction reducing overlay being made of a low friction material formed onto the ticking material, the friction reducing overlay comprising a plurality of overlay elements that are spaced apart from each other to form an overlay pattern.

In some embodiments, the overlay pattern comprises the overlay elements distributed along a plurality of rows and a plurality of columns generally perpendicular to each other.

In some embodiments, the rows extend in a generally lateral direction of the cover and the columns extend in a generally longitudinal direction of the cover.

In some embodiments, the overlay pattern is formed such that opposed longitudinal ends of the overlay elements of two consecutive rows are aligned with each other.

In some embodiments, the overlay pattern is formed such that the overlay elements of two consecutive columns overlap each other in a lateral direction of the cover.

In some embodiments, in a sample portion of the overlay pattern measuring one square inch, a coverage of the low friction material on the ticking is between 50% and 80%.

In some embodiments, the friction reducing overlay extends along a generally rectangular area.

In some embodiments, each of the overlay elements has a quadrilateral shape.

In some embodiments, each of the overlay elements is generally diamond shaped.

In some embodiments, each of the overlay elements has first and second longitudinal ends and first and second lateral ends; and the first and second longitudinal ends and the first and second lateral ends are rounded.

In some embodiments, each of the overlay elements defines an opening through which the ticking material of the cover is exposed.

In some embodiments, the opening is generally oval.

In some embodiments, the ticking material has a first friction coefficient; the low friction material has a second friction coefficient; and the first friction coefficient is greater than the second friction coefficient.

In some embodiments, the ticking material is polyurethane transfer coating on warp knitted polyester fabric or polyurethane transfer coating on weft knitted polyamide fabric.

In some embodiments, the low friction material comprises an ink or plastic that is dried by oxidation and polymerisation.

In some embodiments, the low friction material comprises urethane.

In some embodiments, the friction reducing overlay is one of screen printed, thermal transfer printed, pad printed, digitally printed and hot stamped on the ticking.

In some embodiments, the friction reducing overlay comprises at least one control line interconnecting multiple ones of the overlay elements in order to control elasticity of the cover along the at least one control line.

In some embodiments, the at least one control line extends in one of a lateral direction of the cover and a longitudinal direction of the cover.

In some embodiments, a support surface for a patient support apparatus, comprises: a support layer for supporting a patient on the support surface; and the cover, wherein the ticking encloses the support layer.

In some embodiments, the support surface further comprises a low air loss feature configured to distribute air within the cover.

In some embodiments, at least a portion of the friction reducing overlay is configured to change colors based on at least one physical parameter to indicate a condition related to the person.

In some embodiments, the at least one physical parameter includes one or more of a pressure, a temperature, and a moisture level to which the overlay is exposed.

In some embodiments, the friction reducing overlay comprises a heatable overlay subsystem that is selectively heatable.

In some embodiments, the heatable overlay subsystem is made of graphite.

In some embodiments, the heatable overlay subsystem includes the control lines of the friction reducing overlay.

According to another aspect of the present technology, there is provided a method for manufacturing a cover for a support surface, the method comprising: providing a ticking having an outer top surface configured to face a person supported on the support surface, the ticking being made of a ticking material; and forming a friction reducing overlay, made of a low friction material, on the outer top surface of the ticking in order to form an overlay pattern comprising a plurality of overlay elements that are spaced apart from each other.

In some embodiments, forming the friction reducing overlay on the outer top surface of the ticking comprises one of screen printing, thermal transfer printing, pad printing, digitally printing or hot stamping the friction reducing overlay on the outer top surface of the ticking.

Embodiments of the present technology each have at least one of the above-mentioned objects and/or aspects, but do not necessarily have all of them. It should be understood that some aspects of the present technology that have resulted from attempting to attain the above-mentioned objects may not satisfy these objects and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view, taken from a top, right side, of a support surface according to an embodiment of the present technology, shown with a patient lying on the support surface;

FIG. 2 is an exploded view, taken from a top, right side, of the support surface of FIG. 1;

FIG. 3 is an exploded view, taken from a bottom, right side, of the support surface of FIG. 1;

FIG. 4 is an exploded view, taken from a top, right side, of an air distribution manifold and a support layer of the support surface of FIG. 1;

FIG. 5 is a top plan view of a top cover portion of a cover of the support surface of FIG. 1, showing a friction reducing overlay of the cover;

FIG. 6 is a detailed view of section A of the top cover portion shown in FIG. 5;

FIG. 7 is a detailed view of a sample portion of an overlay pattern of the friction reducing overlay shown in FIG. 5; and

FIG. 8 is a top plan view of the top cover portion of the support surface in accordance with an alternative embodiment of the friction reducing overlay;

FIG. 9 is a detailed view of a part of the friction reducing overlay of FIG. 8;

FIG. 10 is a top plan view of a part of the friction reducing overlay according to another alternative embodiment; and

FIG. 11 is a block diagram of a controller connected to a heatable overlay subsystem of the overlay in accordance with another embodiment.

### DETAILED DESCRIPTION

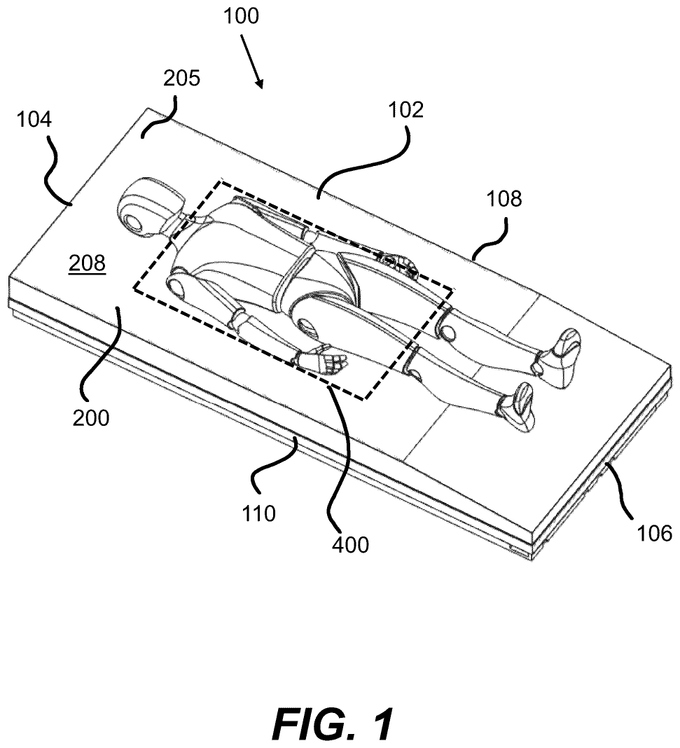

A support surface 100 in accordance with an embodiment of the present technology is illustrated in FIG. 1. In this embodiment, the support surface 100 is a mattress that is used in conjunction with a patient support apparatus, such as a bed (e.g., a hospital bed). Notably, the mattress 100 may be used in a medical setting, such as a in a hospital or a long care living institution, to comfortably support a patient thereon (as illustrated in FIG. 1). Other types of support surfaces such as integrated bed systems and seat cushions are also contemplated. As will be described in more detail below, in accordance with the present technology, the mattress 100 has a cover that is configured to facilitate displacement of the patient lying thereon, namely by limiting friction between the patient and the cover. This can be beneficial for the comfort of the patient when he/she is repositioned, such as when a head portion of the mattress 100 is raised (e.g., via operation of the accompanying bed) to bring the patient to a sitting position on the mattress 100.

With reference to FIG. 1, the mattress 100 has a head end 104 and a foot end 106 opposite each other and defining a longitudinal dimension (i.e., a length) of the mattress 100 therebetween. As will be appreciated, in use, when the patient is lying on the mattress 100, the patient's head is closer to the head end 104 while the patient's feet are closer to the foot end 106. The mattress 100 also has a left end 108 and a right end 110 which define a lateral dimension (i.e., a width) of the mattress 100 therebetween. In the present description, the terms “head”, “foot”, “right” and “left” are used to describe the position or orientation of some of the components of the mattress 100. These terms are to be understood from a reference point of an individual lying on their back on the mattress 100 with their head oriented toward the head end 104 of the mattress 100 and their feet oriented toward the foot end 106 of the mattress 100.

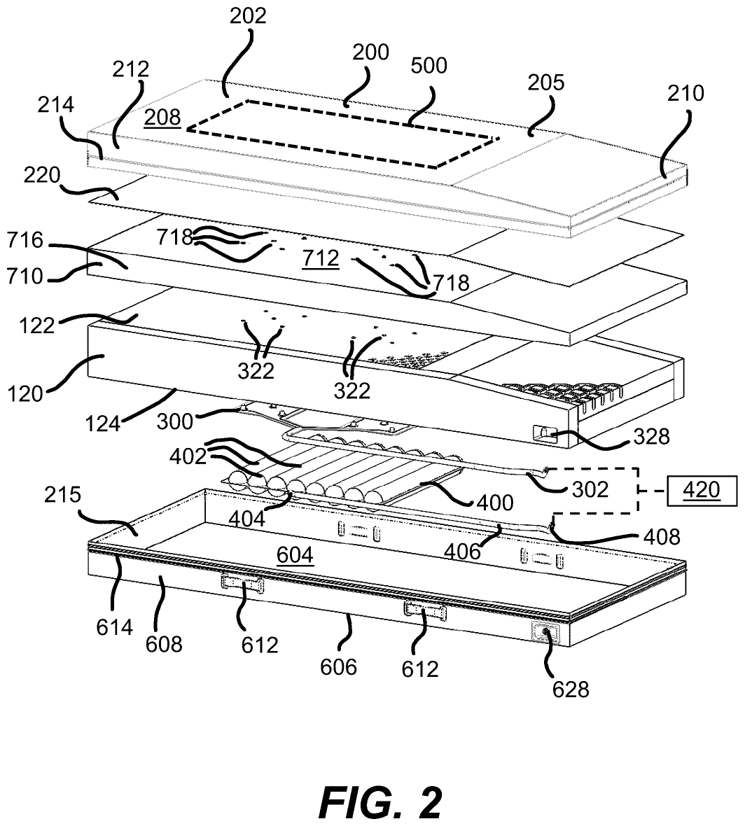

As shown in FIG. 2, the mattress 100 has a support layer 120 that is configured to support the patient. In other words, the support layer 120 is the principal component of the mattress 100 responsible for ensuring proper support of the patient thereon. The support layer 120 has an upper surface 122 which, in use, faces upwardly toward the patient lying on the mattress 100, and a lower surface 124 opposite the upper surface 122. The support layer 120 is designed to be resilient such that, when the patient lies on the mattress 100, the support layer 120 deforms under the weight of the patient and conforms to the shape of the patient's body, effectively enveloping part of the patient's body. This immersion of the patient's body into the support layer 120 allows a distribution of the patient's weight over a greater surface area, thereby contributing to the comfort of the patient and minimizing the risk of developing pressure ulcers (e.g., for a patient with limited mobility or a patient confined to a bed for a long duration for any given reason).

In this embodiment, the support layer 120 is made of one or more resilient materials. More specifically, in this example, the support layer 120 is formed from multiple distinct pieces having different rigidities. For instance, in this embodiment, the support layer 120 has a central portion 126 that has a different rigidity from left and right portions 128, 130 of the resilient support layer 120 disposed on the left and right sides of the central portion 126 respectively. In particular, the resilient material of the left and right portions 128, 130 has a greater rigidity than the resilient material of the central portion 126. In this example, each of the central portion 126 and the left and right portions 128, 130 extends along an entirety of the length of the support layer 120. The central portion 126 is spaced from the left and right ends 108, 110 of the patient support 102 by the left and right portions 128, 130. It is contemplated that additional portions of the support layer 120 could have different rigidities (e.g., a foot portion having a different rigidity).

In this embodiment, the support layer 120 is made of foam. The central portion 126 and the left and right portions 128, 130 are thus made from foams having different rigidities. The difference in rigidities between the central portion 126 and the left and right portions 128, 130 may facilitate the patient's immersion into the foam of the central portion 126 while providing more rigid lateral zones which can facilitate the patient's egress from the mattress 100 and minimize the risk of falling off the mattress 100.

It is contemplated that, in other embodiments, the support layer 120 could be made of a different type of resilient material and/or could have a different construction that imparts resilience to the support layer 120. For instance, in some embodiments, the support layer 120 could be made of air-filled pockets. In some embodiments, the support layer 120 could be made of inflatable bladders whose internal pressure can be adjusted by a controller.

Returning to FIG. 1, a cover 200 of the mattress 100 defines the outer boundaries of the mattress 100. Notably, the cover 200 has an outer top surface 208, an outer bottom surface 606 (FIG. 2) opposite the outer top surface 208, and peripheral walls extending therebetween. In use, the outer top surface 208 faces the patient lying on the mattress 100, as shown in FIG. 1, while the outer bottom surface 606 faces the bed or other patient support apparatus that is used in conjunction with the mattress 100. As shown in FIG. 2, in this embodiment, the cover 200 includes a top cover portion 205 and a bottom cover portion 215 that are fastened to each other to enclose the support layer 120 and the other internal components of the mattress 100 therebetween.

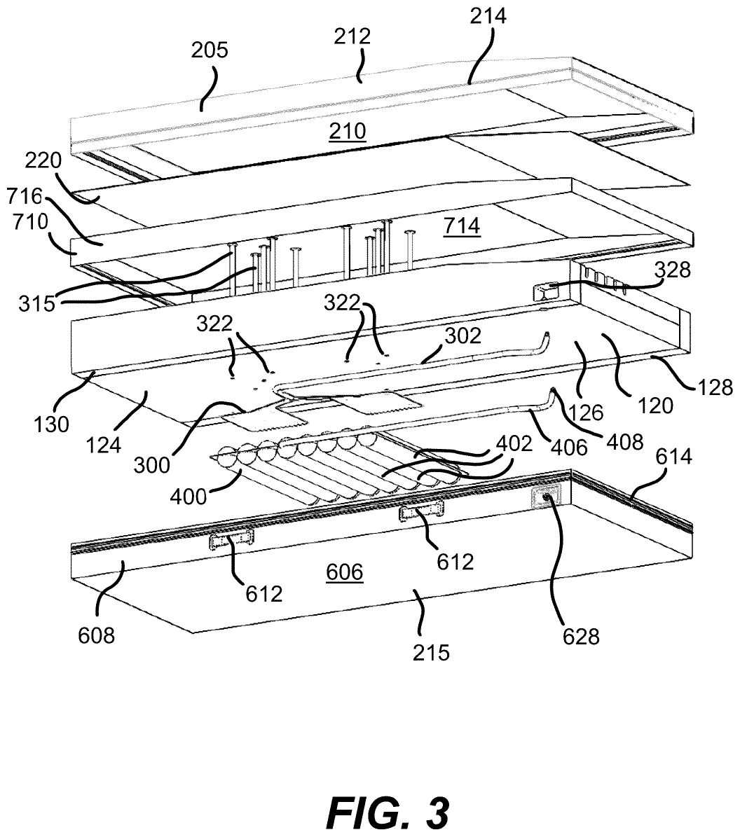

With reference to FIGS. 2 and 3, the top cover portion 205 has a ticking 202 which includes the outer top surface 208, an inner bottom surface 210 (FIG. 3) and a peripheral wall 212 extending downwardly from the outer top surface 208 and inner bottom surface 210. The top cover portion 205 also has an attachment element 214 affixed to the peripheral wall 212. The attachment element 214 is detachably fastened to a corresponding attachment element of the bottom cover portion 215. In this embodiment, the attachment element 214 is a zip fastener that extends along the peripheral wall 212. Other types of attachment elements are also contemplated.

In this embodiment, the ticking 202 is made of a ticking material having a moisture vapor transmission rate (MVTR) that enables humidity and moisture from the patient lying on the mattress 100 to permeate therethrough, into an intermediate air diffusion layer 220 disposed below to regulate the microclimate environment around and/or below the patient. Exemplary MVTR varying between about 50 to 600 g/m²/24 hrs (ASTM E96 upright) may be selected. The ticking 202 may also be made of a four-way or a two-way stretchable material to minimize shear forces in the contact areas between the patient and the ticking 202 in order to improve comfort to the patient. Exemplary ticking materials for the ticking 202 include polyurethane transfer coating on warp knitted polyester fabric or polyurethane transfer coating on weft knitted polyamide fabric as non-limitative examples. Other types of ticking material are also contemplated.

As shown in FIG. 2, the top cover portion 205 has a friction reducing overlay 500 formed on the outer top surface 208. The friction reducing overlay 500 is configured to promote displacement of the patient on the mattress 100 which may be beneficial for the patient's comfort, particularly in situations in which a position of the mattress 100 is changed in such a way as to affect the position of the patient on the mattress 100. The configuration of the friction reducing overlay 500 will be described in greater detail further below.

The bottom cover portion 215 is disposed in part below the support layer 120. Together, the bottom cover portion 215 and the top cover portion 205 form a compartment for enclosing therein the internal components of the mattress 100. In some embodiments, the bottom cover portion 215 is made of a fluid-resistant material. The bottom cover portion 215 has an upper surface 604, an opposed lower surface 606, and a peripheral wall 608 extending upwardly from the upper and lower surfaces 604, 606. The upper and lower surfaces 604, 606 are aligned, longitudinally and transversely, with the lower surface 124 of the support layer 120, while the peripheral wall 608 extends along the periphery of the support layer 120. In this example, handles 612 are provided along the peripheral wall 608, namely on the left and right sides of the bottom cover portion 215.

In this embodiment, the bottom cover portion 215 is attachable to the top cover portion 205. Notably, the bottom cover portion 215 has an attachment element 614 extending at least partially along the peripheral wall 608. The attachment element 614 cooperates with the attachment element 214 of the top cover portion 205 such that the bottom cover portion 215 is at least partially detachable from the top cover portion 205. The attachment elements 214, 614 may be airtight or non-airtight according to specific applications of the mattress 100. Exemplary attachment elements 214, 614 may include a zipper, an elastic band, buttons or attachment straps.

With continued reference to FIGS. 2 and 3, in this embodiment, an air diffusion layer 220 is disposed above the support layer 120 and receives air from an air distribution manifold 300. Notably, the air diffusion layer 220 is configured to diffuse air received from the air distribution manifold 300. The function provided by the air distribution manifold 300 and the air diffusion layer 220 may be referred to as a “low air loss” feature. The air diffusion layer 220 is disposed between the top cover portion 205 and the support layer 120. The air diffusion layer 220 may be made of a compressible and/or crushable and/or resilient material having a selected thickness, such as a fabric that enables air to be distributed therein and to diffuse therethrough, while providing convenient comfort to the patient. For example, the air diffusion layer 220 could be made of a felt fabric, a 3D spacer fabric, or any other suitable fabric in other embodiments. The selected thickness of the air diffusion layer 220 may be from 4 mm to 10 mm as a nonlimitative example.

In this embodiment, the air diffusion layer 220 is attached to the top cover portion 205. For example, the air diffusion layer 220 may be provided with an attachment element (not shown) extending at least partially along its periphery, and the attachment element may cooperate with a corresponding attachment element (not shown) provided on the top cover portion 205 and extending at least partially along the periphery of the top cover portion 205. Exemplary attachment elements may include a zipper, buttons or attachment straps for example in order to provide a removable attachment. Alternatively, the air diffusion layer 220 may be permanently attached to the top cover portion 205, for example by radiofrequency (RF) or ultrasound welding, sewing or other appropriate techniques.

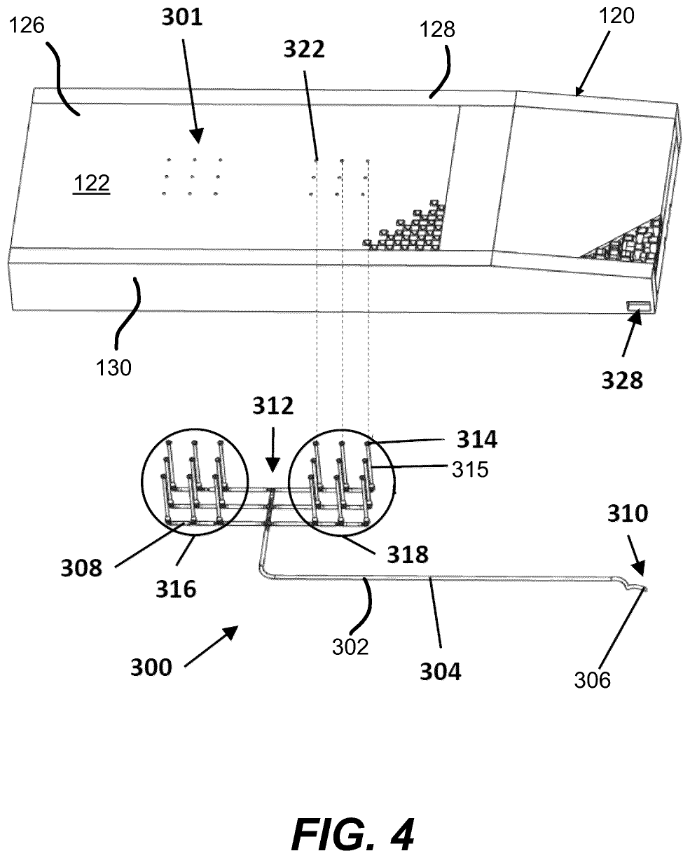

The air distribution manifold 300 is mountable between the top cover portion 205 and the bottom cover portion 215. In this embodiment, the air distribution manifold 300 is mountable at least partially within the support layer 120. As shown in FIG. 4, the air distribution manifold 300 is provided with an elongated conduit 302 mounted horizontally below the lower surface 124 of the support layer 120. The conduit 302 has a main supply hose 304 and a connector 306 extending at a distal end 310 thereof. The connector 306 may be received at an opening 328 defined on the side of the support layer 120 and also in an opening 628 defined on the side of the bottom cover portion 215. The openings 328, 628 may be defined on the lower sides of the support layer 120 and the bottom cover portion 215 respectively in other embodiments. The conduit 302 also has a plurality of supply hose extensions 308 extending at an end portion 312 opposed to the distal end 310 thereof and operatively connected to the main supply hose 304. In this example, three supply hose extensions 308 are provided parallel to each other on each side of the end portion 312 of the main supply hose 304. The air distribution manifold 300 further has a plurality of air distribution conduits 315, each being operatively connected to the main supply hose 304 through a corresponding supply hose extension 308, and each extending substantially perpendicularly therefrom.

As shown in FIG. 4, the arrangement of the air distribution conduits 315 defines a predetermined pattern relative to the upper surface 122 of the support layer 120 for defining a microclimate managed area 301. In this embodiment, the air distribution conduits 315 are arranged in first and second distant groups 316, 318, each configured to distribute air to a specific distinct area. In this embodiment, the support layer 120 has a plurality of air circulation apertures 322 extending from the upper surface 122 to the lower surface 124. Notably, in this embodiment, the air distribution conduits 315 are mounted within respective ones of the air circulation apertures 322.

The air distribution manifold 300 may be configured differently in other embodiments.

The air distribution manifold 300 is in fluid communication with a pump 420 (schematically illustrated in FIG. 2) in order to receive air therefrom. Notably, the air received from the pump is discharged via the air distribution conduits 315 to the air diffusion layer 220 where the air is diffused. A controller controls the operation of the pump 420 in order to selectively route air to the air distribution manifold 300. The pump 420 is contained within an external pump unit (not shown) that is kept close to the mattress 100 (e.g., at the foot end of the bed).

The air diffusion layer 220 and the air distribution manifold 300 could be omitted in other embodiments.

With reference to FIGS. 2 and 3, in this embodiment, the mattress 100 also includes an inflatable bladder 400 that can be selectively inflated to temporarily rigidify a portion of the mattress 100 on which the patient is lying. This may facilitate the patient's egress from the mattress 100, namely by countering an immersion of the patient into the mattress 100. The inflatable bladder 400 is disposed between the support layer 120 and the bottom cover portion 215. The inflatable bladder 400 has a plurality of elongated cells 402 that are in fluid communication with each other. In this embodiment, the inflatable bladder 400 is positioned such that each elongated cell 402 thereof is elongated in a transverse direction of the patient support 102. It is contemplated that, in other embodiments, the elongated cells 402 could be oriented differently. As shown in FIG. 2, in this example, the inflatable bladder 400 has a single port 404 through which air flows into and out of the inflatable bladder 400. It is contemplated that, in other embodiments, the bladder 400 may be provided with additional ports. A conduit 406 is fluidly connected to the port 404 for routing air to the inflatable bladder 400. A distal end of the conduit 406 may be provided with a connector 408 that is received in the openings 328, 628 of the support layer 120 and the bottom layer 602.

The inflatable bladder 400 is in selective fluid communication with the pump 420 to receive air therefrom.

The inflatable bladder 400 could be omitted in other embodiments.

As shown in FIGS. 2 and 3, in this embodiment, a fluid-resistant envelope 710 overlies the support layer 120. The fluid-resistant envelope 710 has an upper surface 712, an opposed lower surface 714 and a peripheral wall 716 extending downwardly from the upper and lower surfaces 712, 714. The peripheral wall 716 extends along the periphery of the support layer 120. The fluid-resistant envelope 710 is configured to protect the support layer 120 and other internal components of the mattress 100 from exposure to liquids. In this embodiment, the fluid-resistant envelope 710 defines a plurality of air circulation apertures 718 (FIG. 2) in fluid communication with the air distribution conduits 315 for enabling free air circulation though the fluid-resistant envelope 710. Notably, the air circulation apertures 718 are aligned with the air circulation apertures 322 of the support layer 120. In some cases, the air distribution conduits 315 may be welded or otherwise fastened to the fluid-resistant envelope 710 to further ensure that liquids do not pass through the fluid-resistant envelope 710. The fluid-resistant envelope 710 may be attached to the bottom cover portion 215 or to the support layer 120 in any suitable way (e.g., via appropriate attachment elements).

It is contemplated that, in some embodiments, the fluid-resistant envelope 710 could enclose the support layer 120, the air distribution manifold 300 and the inflatable bladder 400.

The fluid-resistant envelope 710 may be omitted in other embodiments.

As mentioned above, an important characteristic of the mattress 100 is the breathability of the cover 200, namely of the outer top surface 208, as it contributes greatly to the patient's comfort. The breathability of the outer top surface 208 may be particularly important for the mattress 100 when it has a low air loss function, provided for example by the air distribution manifold 300 and the air diffusion layer 220 described above, as the air diffused thereby may have to traverse the outer top surface 208 in some cases. The friction reducing overlay 500 of the cover 200 is able to maintain this breathability at the outer top surface 208 while also providing a reduced friction area along the outer top surface 208. Moreover, in this embodiment, the friction reducing overlay 500 is designed to maintain the elasticity of the ticking material of the ticking 202 of the cover 200.

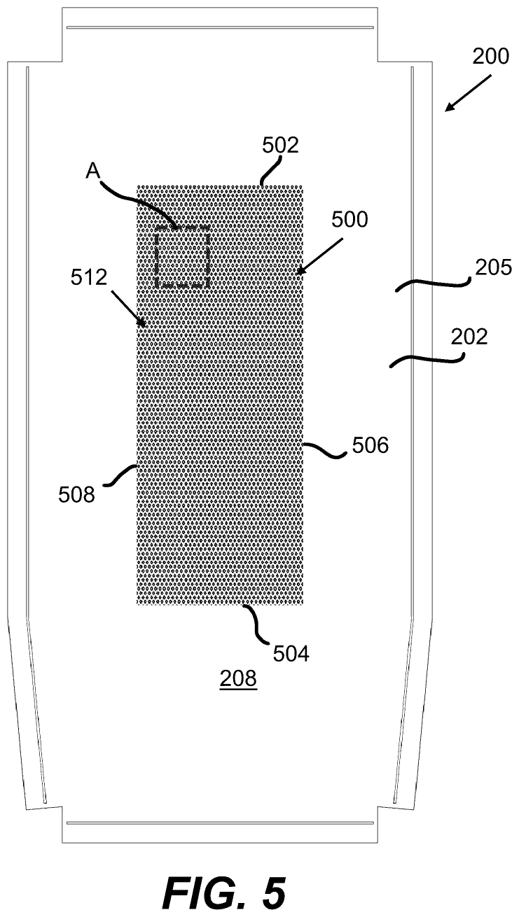

The friction reducing overlay 500 of the cover 200 will now be described in greater detail with reference to FIGS. 5 to 7. As mentioned above, the friction reducing overlay 500 is configured to facilitate displacement of the patient on the outer top surface 208 which may be beneficial for the patient's comfort, namely when the position of the mattress 100 is changed (e.g., when the head portion of the bed is raised). Particularly, by reducing the friction at the outer top surface 208, the patient may slide lightly on the outer top surface 208 thereby avoiding or otherwise reducing a sensation that the patient may have of being compressed around their midsection when the mattress 100 transitions to a sitting position. The friction reducing overlay 500 achieves this without affecting the breathability of the top cover portion 205. Furthermore, by promoting the displacement of the patient on the cover 200, the friction reducing overlay 500 may facilitate repositioning the patient on the mattress 100 by caregivers (e.g., moving the patient toward the head end of the mattress 100).

With reference to FIG. 5, the friction reducing overlay 500 extends longitudinally from a head end 502 to a foot end 504, and laterally from a left end 506 to a right end 508. As can be seen, in this embodiment, the friction reducing overlay 500 is generally rectangular, but the friction reducing overlay 500 could have a different shape in other embodiments (e.g., an oblong shape). The friction reducing overlay 500 extends along a dorsal portion of the cover 200 (i.e., a portion of the cover 200 configured to be aligned with a back of the patient when he/she is lying on the cover 200) and a seat portion of the cover 200 (i.e., a portion of the cover 200 configured to be aligned with the hips, glutes and upper legs of the patient when he/she is lying on the cover 200). As such, the head end 502 of the friction reducing overlay 500 is disposed along the dorsal portion of the cover 200, spaced from a head end of the cover 200, while the foot end 504 of the friction reducing overlay 500 is disposed along the seat portion of the cover 200, spaced from the foot end of the cover 200.

In other embodiments, the friction reducing overlay 500 may extend along a more limited area (e.g., only along the dorsal portion or only along the seat portion), or along a greater area of the outer top surface 208 (e.g., additionally along a foot portion of the cover 200).

The friction reducing overlay 500 is made of a low friction material to facilitate displacement of the patient on the cover 200. Notably, the low friction material has a friction coefficient that is lower than a friction coefficient of the ticking material of the ticking 202. In this embodiment, the low friction material comprises an ink or plastic that is dried by oxidation. In particular, the low friction material comprises an ink or plastic is dried by oxidation and polymerisation. Non-limitative examples include urethane amongst others. It is contemplated that the low friction material could comprise additional materials and/or a different material in other embodiments.

In this embodiment, the friction reducing overlay 500 is formed by screen printing. That is, in order to produce the friction reducing overlay 500, the low friction material of the friction reducing overlay 500 is applied as a resin on the outer top surface 208 of the cover 200 and cured by exposure to light. The friction reducing overlay 500 may be formed in different ways onto the ticking 202. For example, the friction reducing overlay 500 may be thermal transfer printed, pad printed, digitally printed or hot stamped onto the ticking 202 in other embodiments.

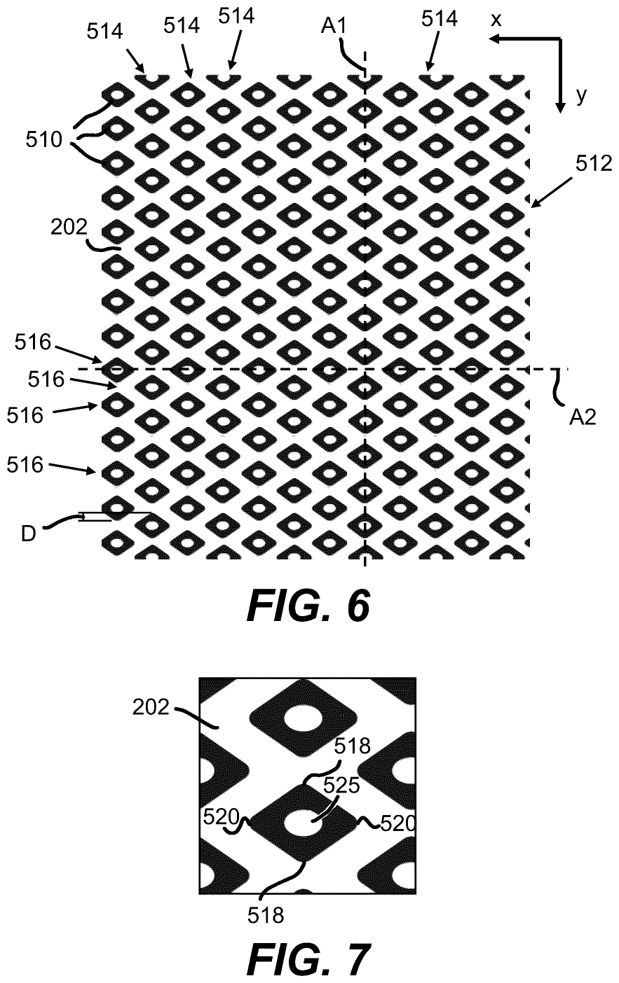

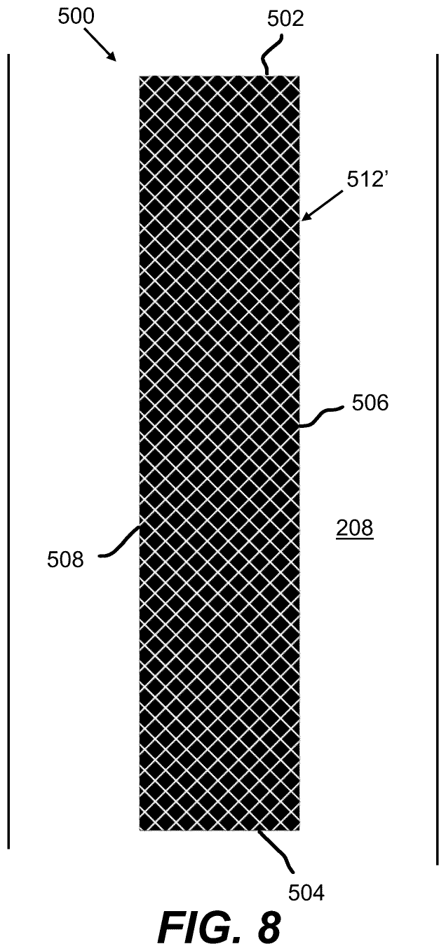

With reference to FIGS. 6 and 7, the friction reducing overlay 500 comprises a plurality of overlay elements 510 that are spaced apart from each other to form an overlay pattern 512. The spacing between the overlay elements 510 allows the ticking material of the ticking 202 to be exposed along the area of the friction reducing overlay 500, thereby not substantially affecting the breathability of the outer top surface 208. Specifically, the overlay pattern 512 has been designed to provide sufficient coverage of the ticking 202 so as to promote sliding of the patient on the outer top surface 208 but not so much coverage of the ticking 202 so as to negatively affect the breathability of the ticking 202. Notably, in a sample portion of the overlay pattern 512 measuring one square inch (i.e., 6.45 mm²) illustrated for example in FIG. 7, a coverage of the low friction material on the ticking 202 may be less than 80%. For instance, the coverage of the low friction material on the ticking 202 in a sample portion of the overlay pattern 512 measuring one square inch may be between 50% and 80%. The coverage of the low friction material on the ticking in the sample portion of the overlay pattern 512 measuring one square inch may be between 60% and 70%. In this embodiment, the coverage of the low friction material on the ticking 202 in a sample portion of the overlay pattern 512 measuring one square inch is approximately 64% (±2%).

As shown in FIG. 6, in this embodiment, the overlay pattern 512 is formed by the overlay elements 510 being distributed along a plurality of rows 514 and a plurality of columns 516 that are generally perpendicular to each other. In this example, the overlay elements 510 of each row 514 are aligned with each other such that a linear axis A1 can be traced to extend generally through the center of each overlay element 510 of that row 514. Similarly, in this example, the overlay elements 510 of each column 516 are aligned with each other such that a linear axis A2 can be traced to extend generally through the center of each overlay element 510 of that column 516. Furthermore, in this embodiment, the rows 514 extend in the lateral direction of the mattress 100 (designated as the y-axis in FIG. 6) while the columns 516 extend in the longitudinal direction of the mattress 100 (designated as the x-axis in FIG. 6). It is contemplated that the rows and columns could extend in different directions in other embodiments (e.g., diagonally).

In this embodiment, the rows 514 and column 516 are configured to be consecutively offset. That is, the overlay elements 510 of one row 514 are offset from the overlay elements 510 of a consecutive row 514, and similarly the overlay elements 510 of one column 516 are offset from the overlay elements 510 of a consecutive column 516. For instance, the overlay elements 510 of one row 514 are offset along the direction of the x-axis (perpendicular to the y-axis along which the rows 514 extend) from the overlay elements 510 of a consecutive row 514. More specifically, a linear axis traced along the x-axis through the center of an overlay element 510 of one row 514 does not extend through the center of an overlay element 510 of a consecutive row 514. Similarly, the overlay elements 510 of one column 516 are offset along the direction of the y-axis (perpendicular to the x-axis along which the columns 516 extend) from the overlay elements 510 of a consecutive column 516. More specifically, a linear axis traced along the y-axis through the center of an overlay element 510 of one column 516 does not extend through the center of an overlay element 510 of a consecutive column 516. In addition, in this embodiment, a linear axis traced along the y-axis through any point of an overlay element 510 of one column 516 does not extend through an overlay element 510 of a consecutive column 516. Notably, as will be described in more detail below, the columns 516 are generally disposed in a stacked configuration that allows consecutive columns 516 to be close to each other but significantly offset from one another.

With reference to FIG. 7, in this embodiment, each of the overlay elements 510 has a quadrilateral shape, namely having two opposed lateral ends 518 and two opposed longitudinal ends 520. A width of each overlay element 510 is measured between its lateral ends 518, and a length of each overlay element 510 is measured between its longitudinal ends 520. In this example, each of the overlay elements 510 is generally diamond shaped, with a distance between the lateral ends 518 being smaller than a distance between the longitudinal ends 520. Furthermore, in this embodiment, the lateral and longitudinal ends 518, 520 are rounded. This may help minimize the chances of the overlay elements 510 clinging onto a fabric disposed atop the cover 200 (e.g., a sheet covering the mattress 100 or the patient's clothing).

In addition, in this example, each of the overlay elements 510 defines an opening 525 through which the ticking material of the cover 200 is exposed. The opening 525 is generally centered with respect to a periphery of the overlay element 510 and is generally oval. The opening 525 may have a different shape or be aligned differently with respect to the periphery of the overlay element 510 in other embodiments. The opening 525 may minimize an impact of the low friction material on the elasticity of the ticking material of the cover 200, particularly locally at the site of the overlay element 510. The opening 525 of the overlay element 510 may be omitted in other embodiments.

The shape of the overlay elements 510 may be helpful to allow the columns 516 to be close to each other. For instance, in this embodiment, the overlay elements 510 of two consecutive columns 516 overlap each other along the y-axis (i.e., in the lateral direction) by a distance D (FIG. 6) that is relatively large. A ratio of the distance D over the dimension of the overlay elements 510 along the y-axis (i.e., the width of the overlay elements 510 between the lateral ends 518 thereof) may be between 20% and 50%. The distance D may decrease during use as the patient's weight will cause the outer top surface 208 to stretch in the lateral direction. In the longitudinal direction, the overlay elements 510 of two consecutive rows 514 are also close to each other. In particular, in this embodiment, a linear axis extending through one of the longitudinal ends 520 (the distal or proximal longitudinal ends 520) of the overlay elements 510 of a given row 514 extends through the opposite longitudinal ends 520 of the overlay elements 510 of a consecutive row 514. This allows a certain continuity in exposure to low friction material for the patient as he/she is displaced along the friction reducing overlay 500 which may also facilitate the sliding of the patient on the cover 200.

The above-described friction reducing overlay 500 has been demonstrated in tests to reduce friction by approximately 30% relative to a version of the mattress 100 that does not include the friction reducing overlay 500 (i.e., with the ticking material being fully exposed along the outer top surface 208).

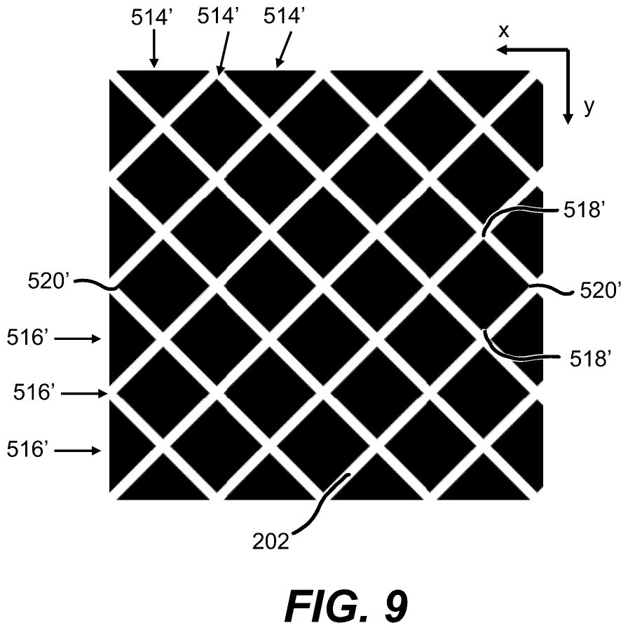

The overlay pattern 512 and the overlay elements 510 may be configured differently in other embodiments. For instance, FIGS. 8 and 9 illustrate an alternative overlay pattern 512′ composed of overlay elements 510′ having a different shape. For ease of reference and to avoid repetition, the same reference numerals used to describe the embodiment of FIGS. 5 to 7 will be used herein, with an apostrophe added as a suffix, to refer to the alternative overlay pattern 512′, the overlay elements 510′ and their features.

As shown in FIG. 9, in this embodiment, each overlay element 510′ has a quadrilateral shape, and more specifically a square shape. The lateral ends 518′ and the longitudinal ends 520′ of the overlay elements 510′ are the vertices thereof. In this alternative embodiment, a center-to-center distance between consecutive rows 514′ (i.e., a distance between the centers of the overlay elements 510′ in one row and the centers of the overlay elements 510′ in a consecutive row) is the same as a center-to-center distance between consecutive columns 516′. As will be appreciated, the overlay pattern 512′ thus has a grid configuration. The coverage of the low friction material on the ticking 202 in a sample portion of the overlay pattern 512′ measuring one square inch may be approximately 78% according to this alternative embodiment. It is contemplated that the spacing between the overlay elements 510′ may be increased in other embodiments to reduce the coverage of the low friction material on the ticking 202.

While in the above-described embodiments, the size and shape of the overlay elements are illustrated and described as being the same along the entirety of the overlay pattern, it is contemplated that the size and shape of the overlay elements may vary along the overlay pattern. For instance, the part of the overlay pattern extending along the dorsal portion of the cover 200 could have a first shape of overlay elements, while the part of the overlay pattern extending along the seat portion of the cover 200 could have a second shape of overlay elements different from the first shape. Similarly, the rows and columns formed by the overlay elements may be configured differently along different parts of the overlay pattern. For example, the rows and/or the columns may be closer or further from one another along the part of the overlay pattern extending along the dorsal portion of the cover 200 or along the part of the overlay pattern extending along the seat portion of the cover 200. These variations may allow a more precise modulation of the characteristics of the cover 200, namely its frictional characteristics, along different portions thereof.

Furthermore, in some embodiments, the friction reducing overlay 500 may include two or more low friction materials having different friction coefficients, and each low friction material may be used along a specific portion of the overlay pattern. In this manner, the reduction in friction offered by the friction reducing overlay 500 may vary along different portions thereof. For example, in some cases, a first low friction material having a first friction coefficient may be used for the friction reducing overlay 500 along the part thereof extending along the dorsal portion of the cover 200, and a second low friction material having a second friction coefficient that is greater than the first friction coefficient, may be used for the friction reducing overlay 500 along the part thereof extending along the seat portion of the cover 200. As such, the friction reducing overlay 500 may promote sliding of the patient on the cover 200 more along the back of the patient than along the glutes and upper legs of the patient.

In yet other embodiments, the friction reducing overlay 500 may include multiple low fiction materials used along a common portion of the overlay pattern. For instance, the overlay elements of the rows and columns may be made of two low friction materials disposed alternatingly. That is, consecutive ones of the overlay elements could be made of two different low friction materials.

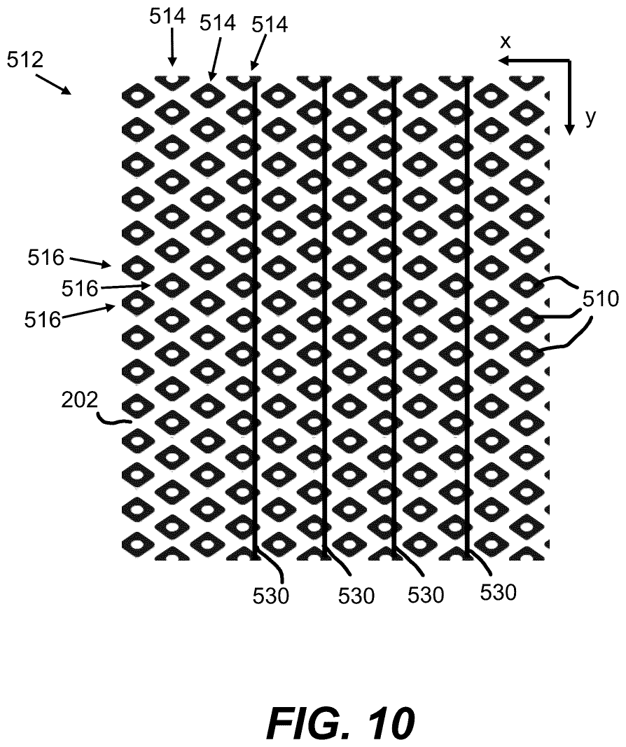

With reference to FIG. 10, in some embodiments, the overlay pattern 512 may include a plurality of control lines 530 interconnecting multiple ones of the overlay elements 510. The control lines 530, which can also be made of the low friction material forming the overlay elements 510, can be used to control an elasticity of the cover 200 along the control lines 530. More specifically, the presence of the control lines 530 may locally reduce the elasticity of the cover 200, as the low friction material may be less flexible than the underlying ticking material of the ticking 202. By ensuring that the control lines 530 extend in a desired direction, the elasticity of the cover 200 is thus decreased in that desired direction. In this example, the control lines 530 extend in direction of the y-axis (i.e., in the lateral direction of the cover 200), interconnecting the overlay elements 510 of a same row 514, and thus the elasticity of the cover 200 along the area in which the control lines 530 are located is decreased relative to an area of the outer top surface 208 that does not comport control lines 530. Notably, as can be seen, some areas of the overlay pattern 512 may not have any control lines 530.

The control lines 530 could extend in other directions in other embodiments. For instance, in some embodiments, the control lines 530 may extend in the direction of the x-axis (i.e., along the longitudinal direction of the cover 200) and interconnect the overlay elements 510 of a same column 516. By modifying the elasticity of the cover 200 via the control lines 530, an immersion of the patient into the mattress 100 may be more limited. As such, the presence of the control lines 530 may facilitate controlling the immersion of the patient into the mattress 100.

It is contemplated that, in some embodiments, the friction reducing overlay 500 may be applied on surfaces other than the outer top surface 208. For instance, in some embodiments, the friction reducing overlay 500 could be applied to the inner bottom surface 210 of the top cover portion 205 in order to reduce friction between the top cover portion 205 and the air diffusion layer 220. Notably, the resulting reduction in friction between the inner surfaces of the mattress 100 may also be beneficial for the patient's comfort when the bed transitions to a seated position.

While the above implementations have been described in the context of reducing friction, it is contemplated that a friction adjusting overlay having a similar overlay pattern to those described above could be implemented at different areas of the top cover portion 205 in order to increase friction at given zones of the mattress 100 where it is desirable for the patient to not slide along the cover 200. That is, the friction adjusting overlay could be made of a material with a greater friction coefficient than the friction coefficient of the ticking 202. For instance, such a friction adjusting overlay could be disposed along a foot portion of the cover 200 so that the patient's feet are prevented from sliding along the top outer surface 208. In some cases, a friction reducing overlay 500 such as that described above could be applied one or more zones of the cover 200 while a friction adjusting overlay that increases friction on the cover 200 could be applied on one or more other zones of the cover 200.

In some embodiments, the overlay 500 may also be configured to adaptively indicate a condition related to the patient. For instance, a color of the overlay 500 may change based on one or more physical parameters that are indicative of the condition of the patient. This may be done by using adaptive pigments in the formulation of the overlay 500. For instance, in one example, the overlay 500 may include a piezochromic pigment having optical properties that change based on mechanical stimuli such as pressure. In other words, a color of the overlay 500 changes based on the pressure applied thereon. As such, if the pressure applied on a given area of the overlay 500 exceeds a given threshold pressure (e.g., 32 mmHg), the given area of the overlay 500 changes from an original color (e.g., white) to a modified color (e.g., cyan). This can give an indication to caregivers when an elevated amount of pressure is being exerted on a particular area so that special care may be taken (e.g., repositioning the patient) to prevent the patient from developing pressure ulcers at those areas.

In one embodiment, the piezochromic reaction is reversible so that after a set amount of time after which the pressure exerted on the given area decreases to less than the given threshold pressure, the color of the overlay 500 at the given area changes back to its original color.

Alternatively or additionally, the overlay 500 may include a thermochromic pigment having optical properties that change based on temperature. That is, the color of the overlay 500 changes based on the temperature to which the overlay 500 is exposed. As such, if the temperature of the overlay 500 increases beyond a given threshold temperature (e.g., 39° C.) at a given area, the original color (e.g., white) of the overlay 500 changes to a modified color (e.g., magenta) at the given area. This can provide a visual indication to a caregiver that the patient's temperature is elevated and that they may therefore need particular attention. In one embodiment, the thermochromic reaction is reversible so that after a set amount of time after which the temperature of the overlay 500 decreases to less than the given threshold temperature, the color of the overlay 500 at the given area changes back to its original color.

Alternatively or additionally, the overlay 500 may include a hydrochromic pigment having optical properties that change based on a moisture level. That is, the color of the overlay 500 changes based on the moisture level to which the overlay 500 is exposed. As such, if the moisture level of the overlay 500 increases beyond a given threshold moisture level (e.g., 60% relative humidity) at a given area, the original color (e.g., white) of the overlay 500 changes to a modified color (e.g., yellow) at the given area. This can provide a visual indication to a caregiver that the patient is exposed to excessive humidity and that they may therefore need particular attention.

In another example, the overlay 500 may include a chromic pigment that has optical properties that change based on exposure to a given chemical compound. In such an example, the overlay 500 may react to compounds that are present in urine for instance. As such, if the overlay 500 is exposed to urine at a given area, the original color (e.g., white) of the overlay 500 changes to a modified color (e.g., red) at the given area. This can provide a visual indication to a caregiver that the patient's clothes should be changed and the mattress and blankets cleaned.

When the overlay 500 is configured to change colors based on two or more physical parameters, the overlay 500 may change colors from its original color to a combined modified color to indicate that the two or more physical parameters have exceeded their respective thresholds. For example, in an embodiment in which the overlay 500 has both piezochromic and thermochromic characteristics, the overlay 500 may change color to a first color (e.g., cyan) when exceeding the pressure threshold, to a second color (e.g., magenta) when exceeding the temperature threshold, and to a third color (e.g., purple) that is a combination of the first and second colors when exceeding the pressure and temperature thresholds.

It is contemplated that the overlay 500 may have the above-mentioned chromic characteristics to indicate a condition related to the patient only along a limited portion of the overlay 500 by ensuring that the composition of the overlay 500 includes the corresponding chromic pigments only along that portion thereof. Moreover, in some embodiments, the overlay 500 may be provided with these chromic characteristics and not necessarily have the friction reducing or friction enhancing characteristics mentioned above.

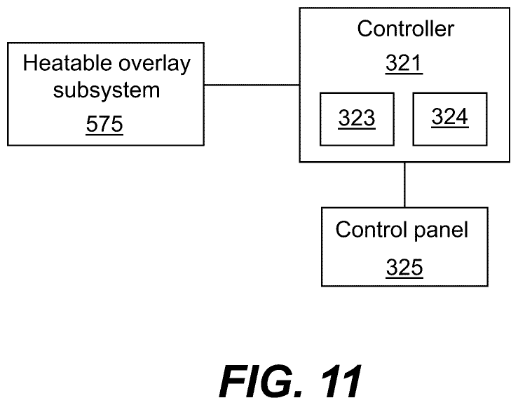

In another embodiment, the overlay 500 may have a heatable overlay subsystem 575 so that the overlay 500 is heatable along at least a portion thereof to selectively provide warmth to the patient. The heatable overlay subsystem 575 includes a conductive material that is heated in response to receiving an electric current. For instance, according to one example, the control lines 530 (FIG. 10) of the overlay 500 may include conductive material so that the control lines 530 are selectively heatable. The conductive material may include graphite or any other suitable conductive material. The conductive material may be coated with another material (e.g., a low friction material) to not expose the patient directly to the conductive material. The heatable overlay subsystem 575 is electrically connected to a controller 321 (FIG. 11) that selectively transmits an electric current thereto. As shown in FIG. 11, the controller 321 is in communication with a control panel 325 provided on the corresponding patient support apparatus (e.g., a hospital bed) or elsewhere, such as a control device separate from the mattress and the patient support apparatus, including for example a remote computing device. The control panel 325 is operated by a user, for example via one or more buttons, to selectively activate the heating of the heatable overlay subsystem 575. The controller 321 may also activate a timer upon activating the heating function of the heatable overlay subsystem 575 so as to automatically turn off the heating of the heatable overlay subsystem 575 after a set amount of time (e.g., 15 minutes).

The controller 321 may be operatively connected to other controllable components of the mattress 100 such as a pneumatic system thereof, which may include, as a non-limiting example, blowers, compressors, pressure sensors, valves and the like. The controller 321 is configured to receive inputs (e.g., from a control panel which can be control panel 325), process the inputs and provide outputs (e.g., to the control panel, to the patient support apparatus, to the pneumatic system components or to other computing devices). In one or more embodiments, the controller 321 may be located within mattress 100. In other embodiments, the controller 321 may be located outside of the mattress 100, such as within or mounted to the patient support apparatus. The controller 321 includes at least a processor 323 and a memory 324. Additionally, the controller 321 may include or be operatively connected to one or more input/output interfaces and communication interfaces (not shown). In one or more implementations, the processor 323 which may also be referred to as a processing device, or a processing unit, may include a single-core microprocessor. In one or more other implementations, the processor 323 may include a multi-core microprocessor. In one or more alternative implementations, the processor 323 may include one or more of: a microcontroller, a digital signal processor (DSP), an integrated circuit purposed for specific operations within an embedded system, a microprocessor, a system on a chip (SoC), a field-programmable gate array (FPGA), and an application-specific integrated circuit (ASIC) configured to carry out the processing and functionalities. The memory 324 may include a volatile and a non-volatile memory. In one or more implementations, the memory 324 may include volatile memory, such as random-access memory (RAM), and/or alternatively static random-access memory (SRAM) or dynamic random-access memory (DRAM). In one or more implementations, the memory 324 may include non-volatile memory, such as flash memory and/or alternatively electrically erasable programmable read-only memory (EEPROM) or ferroelectric RAM (FRAM). The memory 324 is configured to store computer-readable instructions executable by the processor 323 to carry out the processing and functionalities.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A cover for a support surface, comprising:
a ticking made of a ticking material configured to enclose a support layer of the support surface, the ticking having an outer top surface configured to face a person lying on the support surface; and
a friction reducing overlay on at least a portion of the outer top surface for facilitating displacement of the person on the support surface, the friction reducing overlay being made of a low friction material formed onto the ticking material, the friction reducing overlay comprising a plurality of overlay elements that are spaced apart from each other to form an overlay pattern.

2. The cover of claim 1, wherein the overlay pattern comprises the overlay elements distributed along a plurality of rows and a plurality of columns generally perpendicular to each other.

3. The cover of claim 2, wherein the rows extend in a generally lateral direction of the cover and the columns extend in a generally longitudinal direction of the cover.

4. The cover of claim 2, wherein the overlay pattern is formed such that opposed longitudinal ends of the overlay elements of two consecutive rows are aligned with each other.

5. The cover of claim 2, wherein the overlay pattern is formed such that the overlay elements of two consecutive columns overlap each other in a lateral direction of the cover.

6. The cover of claim 1, wherein, in a sample portion of the overlay pattern measuring one square inch, a coverage of the low friction material on the ticking is between 50% and 80%.

7. The cover of claim 1, wherein the friction reducing overlay extends along a generally rectangular area.

8. The cover of claim 1, wherein each of the overlay elements has a quadrilateral shape.

9. The cover of claim 8, wherein each of the overlay elements is generally diamond shaped.

10. The cover of claim 8, wherein:
each of the overlay elements has first and second longitudinal ends and first and second lateral ends; and
the first and second longitudinal ends and the first and second lateral ends are rounded.

11. The cover of claim 1, wherein each of the overlay elements defines an opening through which the ticking material of the cover is exposed.

12. The cover of claim 11, wherein the opening is generally oval.

13. The cover of claim 1, wherein the low friction material comprises an ink or plastic that is dried by oxidation and polymerisation.

14. The cover of claim 1, wherein the low friction material comprises urethane.

15. The cover of claim 1, wherein the friction reducing overlay is one of screen printed, thermal transfer printed, pad printed, digitally printed and hot stamped on the ticking.

16. The cover of claim 1, wherein the friction reducing overlay comprises at least one control line interconnecting multiple ones of the overlay elements in order to control elasticity of the cover along the at least one control line.

17. The cover of claim 1, wherein at least a portion of the friction reducing overlay is configured to change colors based on at least one physical parameter to indicate a condition related to the person.

18. The cover of claim 1, wherein the friction reducing overlay comprises a heatable overlay subsystem that is selectively heatable.

19. A support surface for a patient support apparatus, comprising:
a support layer for supporting a person on the support surface; and
the cover of claim 1, wherein the ticking encloses the support layer.

20. A method for manufacturing a cover for a support surface, the method comprising:
providing a ticking having an outer top surface configured to face a person supported on the support surface, the ticking being made of a ticking material; and
forming a friction reducing overlay, made of a low friction material, on the outer top surface of the ticking in order to form an overlay pattern comprising a plurality of overlay elements that are spaced apart from each other.

21. The method of claim 20, wherein forming the friction reducing overlay on the outer top surface of the ticking comprises one of screen printing, thermal transfer printing, pad printing, digitally printing or hot stamping the friction reducing overlay on the outer top surface of the ticking.

22. A cover for a support surface, comprising:
a ticking made of a ticking material configured to enclose a support layer of the support surface, the ticking having an outer top surface configured to face a person lying on the support surface; and
a friction reducing overlay on at least a portion of the ticking, the friction reducing overlay being made of a low friction material formed onto the ticking material, the friction reducing overlay comprising a plurality of overlay elements that are spaced apart from each other to form an overlay pattern.
